(19) United States
(12) Patent Application Publication
(10) Pub. No.: US 2010/0166616 A1
(43) Pub. Date: Jul. 1, 2010

(54) PIPETTE TIP RACK AND ASSOCIATED METHODS

(76) Inventor: West L. Price, Draper, UT (US)

Correspondence Address: TRASKBRITT, P.C., P.O. BOX 2550, SALT LAKE CITY, UT, 84110, US

(21) Appl. No.: 12/733,078

(22) PCT Filed: Sep. 19, 2008
(86) PCT No.: PCT/US2008/010934

§ 371 Date: Feb. 8, 2010

Related U.S. Application Data
(60) Provisional application No. 60/973,648, filed on Sep. 19, 2007.

(51) Int. Cl. B01L 9/00

(52) U.S. Cl. 422/104

(57) ABSTRACT

Described is a pipette tip rack (100) and methods of making the same. The pipette tip rack is constructed of biodegradable material so that it can be disposed of in a landfill without significant environmental impact. The rack may be structured from folded sheet material, generally in the manner of a cardboard box, such that it is sufficiently rigid for practical use in pipetting procedures. The rack may be fashioned in various other configurations, such as any of the known arrangements used to hold test tubes or pipettes (300) in a specified orientation. The tip racks are sufficiently robust to withstand the loads inherently encountered as a pipette probe engages tips stored in them and are biodegradable within a practical time frame. Pipette tip racks of the type conventionally constructed and arranged to hold a plurality of pipette tips in a specified arrangement for engagement by a probe is improved by constructing the rack from a biodegradable material selected and configured to resist forces applied by that probe during a tip-mounting operation.

### PRIORITY CLAIM

This application claims the benefit of the filing date of U.S. Provisional Patent Application 60/973,648, filed on Sep. 19, 2007.

### TECHNICAL FIELD

The invention relates generally to packaging suitable for laboratory equipment, specifically a container for pipette tips, and methods of making and using the same.

### BACKGROUND

Pipette tips may be manually manipulated or robotically manipulated for use individually, or to register with the individual wells of well assay plates.

Well assay plates comprise individual wells (analogous to miniature test tubes) organized in ranks and files in standardized patterns. Pipette tips are moved into position to register with individual wells by means of a probe. The probe is manipulated, either manually or by means of a robotic arm to engage a plurality of individual tips. The probe is used to transport the tips into registration with the wells of the assay plate. The pipette tip includes a tapered inner passageway, and the insertion of the cylindrical probe into the pipette tip generates an interference fit. Mounting the pipette tip on the probe effects a fluid tight seal between the probe peripheral cylindrical surface and the tapered annular inner wall of the pipette tip. The reliance on the taper of the passageway in the pipette tip does not permit precise sealing and alignment of the pipette with the probe. In addition, the force needed to load the pipette tip on the probe may vary.

Conventionally, the pipette tips are arranged in an array in plastic trays. (See, e.g., U.S. Pat. Nos. 4,676,377 to Rainin et al., 5,392,914 to Lemieux et al., 6,514,466 to Labriola et al., 5,318,753 to Honda, 5,057,282 to Linder, 3,853,217 to Scordato et al., and 4,676,377 to Rainin et al.) After use, both the pipette tips and the plastic trays are discarded. The plastic tray must be sufficiently rigid to resist the force of the probe while mounting the pipette tip. Thus, the plastic tray includes a large amount of plastic. Modern social and political considerations disfavor the incineration or physical disposal; e.g., in landfills, of plastic. Either disposal method causes negative environmental impact.

### DISCLOSURE OF THE INVENTION

A pipette tip rack is constructed of biodegradable material, such as cardboard, recycled paper, paperboard, wood, wicker, cellulose, or paper, so that it can be disposed of in a landfill without significant environmental impact. The rack may be structured from folded sheet material, generally in the manner of a cardboard box, such that it is sufficiently rigid for practical use in pipetting procedures. The rack may be fashioned in various other configurations, such as any of the arrangements traditionally used to hold test tubes or pipettes in a specified orientation. Properties of the tip racks of the invention are that (1) they be sufficiently robust to withstand the loads inherently encountered as a pipette probe engages tips stored in them and (2) they are biodegradable within a practical time frame. According to this invention, pipette tip racks of the type conventionally constructed and arranged to hold a plurality of pipette tips in a specified arrangement for engagement by a probe is improved by constructing the rack from a biodegradable material selected and configured to resist forces applied by that probe during a tip-mounting operation.

Described is a tray for pipette tips that provides sufficient resistance to mount a pipette tip on a probe, yet creates less waste. Described is a tray constructed of a material that is biodegradable within a short time period in a landfill.

### BRIEF DESCRIPTION OF THE DRAWINGS

FIG. 1 is a perspective view of a first embodiment of a container of the invention.

FIG. 2 is an illustration of the container of FIG. 1 with one end unfolded.

FIG. 3 is a side view of the container of FIG. 1.

FIG. 4 is another view of the container of FIG. 1.

FIG. 5 is an illustration of an embodiment of a blank for a container.

FIG. 6 is an illustration of an embodiment of a blank for a lid for a container.

### MODE(S) FOR CARRYING OUT THE INVENTION

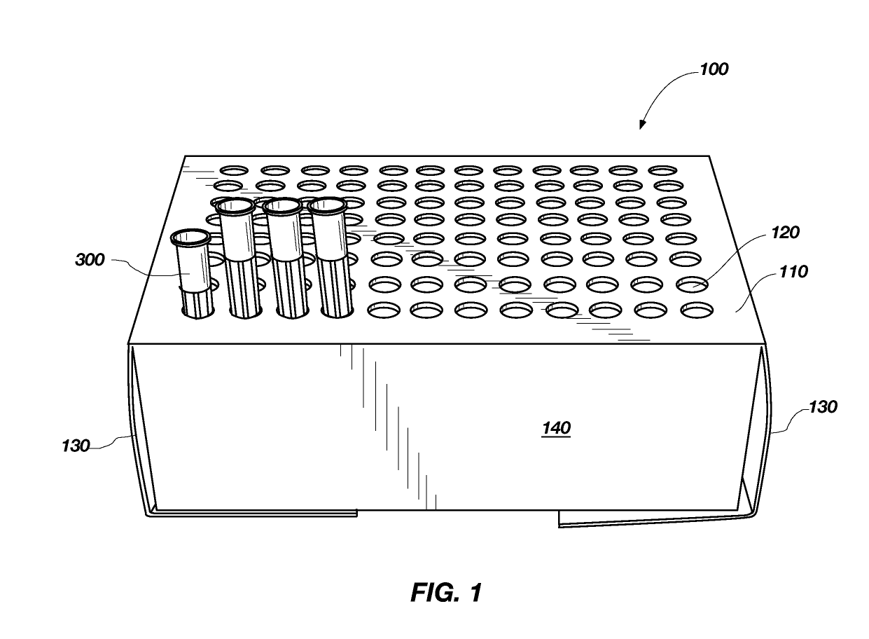

FIG. 1 depicts a first embodiment of a container 100 of the invention. The container 100 comprises a top wall 110 including an array of apertures 120 configured for receiving pipette tips 300. The container 100 further includes two end walls 130, two sidewalls 140, and a floor 180 (FIG. 4). Only one sidewall 140 is shown in the view of FIG. 1. In certain embodiment, the container 100 may include an array of ninety-six (96) apertures 120, arranged in an eight (8) by twelve (12) array. The pipette tips 300 may include, e.g., external ribs (not shown) or other means for preventing the pipette tips 300 from being inserted too far within apertures 120. The pipette tips 300 may be supported on the ribs by the top wall 110 surrounding each aperture 120.

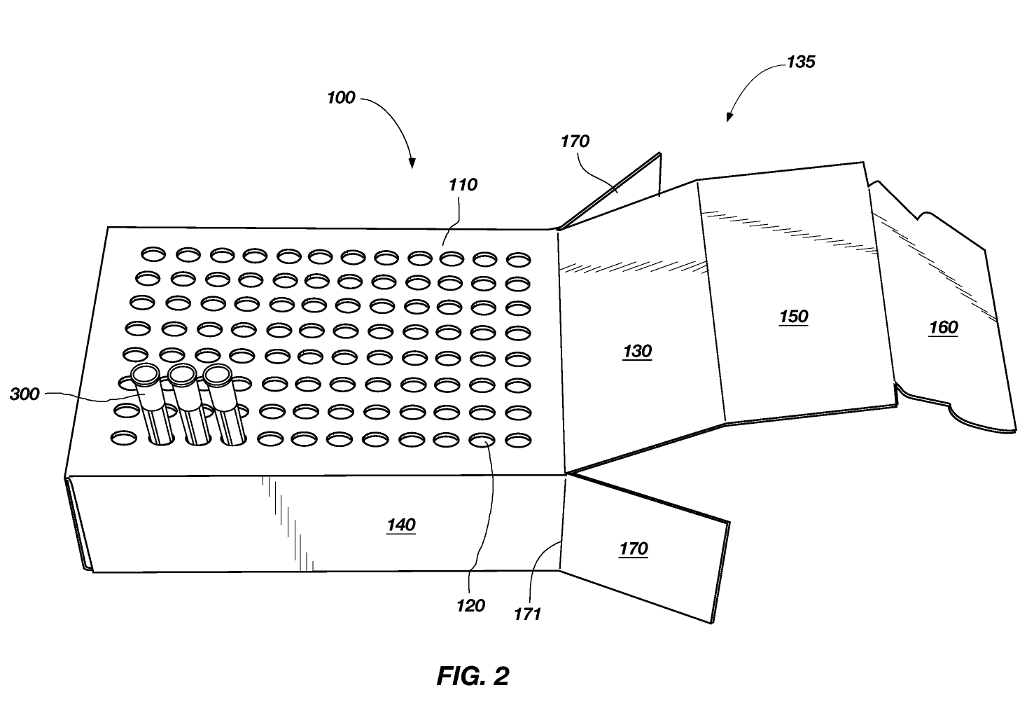

FIG. 2 depicts a perspective view of the container 100, with one end 135 partially unfolded. The end 135 includes two end flaps 170 which may be attached to the sidewalls 140 along fold lines 171. The end 135 further includes the end wall 130, a floor section 150 and an inner support wall 160. When the end 135 in is the folded, closed position, the floor section may wrap around and cover a portion of the floor 180 (see FIG. 4).

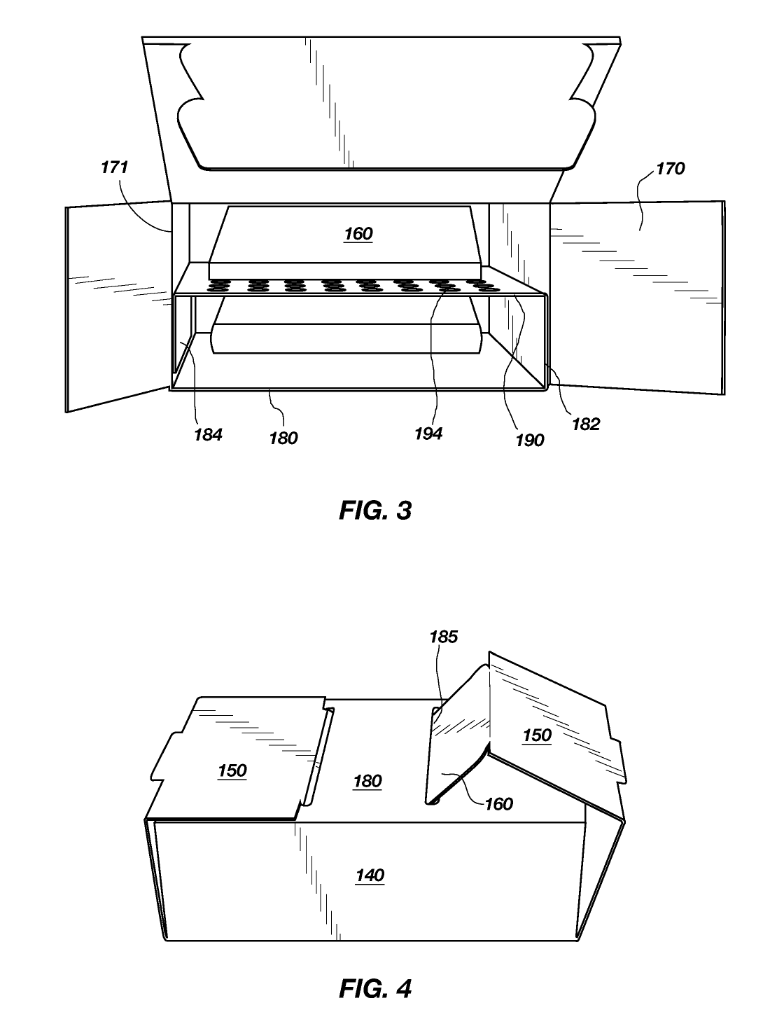

FIG. 3 illustrates an end view of the container 100 with the end 135 partially unfolded for a view of the inside of the container 100. A lower panel 190 includes an array of apertures 194 aligned with the array of apertures 120 of the top wall 110. The apertures 194 of the lower panel 190 may be smaller than the apertures 120 of the top wall 110. The apertures 120 of the top wall 110 may be configured to receive an upper portion of a pipette tip 300, while the apertures 194 of the lower panel 190 may be configured to receive a lower, tapered portion of the pipette tip 300. The apertures 120 and the apertures 194 may be, for example, spaced on 9 mm centers for use with a micro pipettor and pipette tips with a volume of between about 5 μl and about 1,000 μl. For use with an ultra micro pipettor and pipette tips having a volume of between about 1 μl and about 10 μl, the apertures 120, 194 may be smaller and spaced closer together. For use with a macro pipettor and pipette tips having a volume of between about 1 ml and about 15 ml, the apertures 120, 194 may be larger and spaced farther apart.

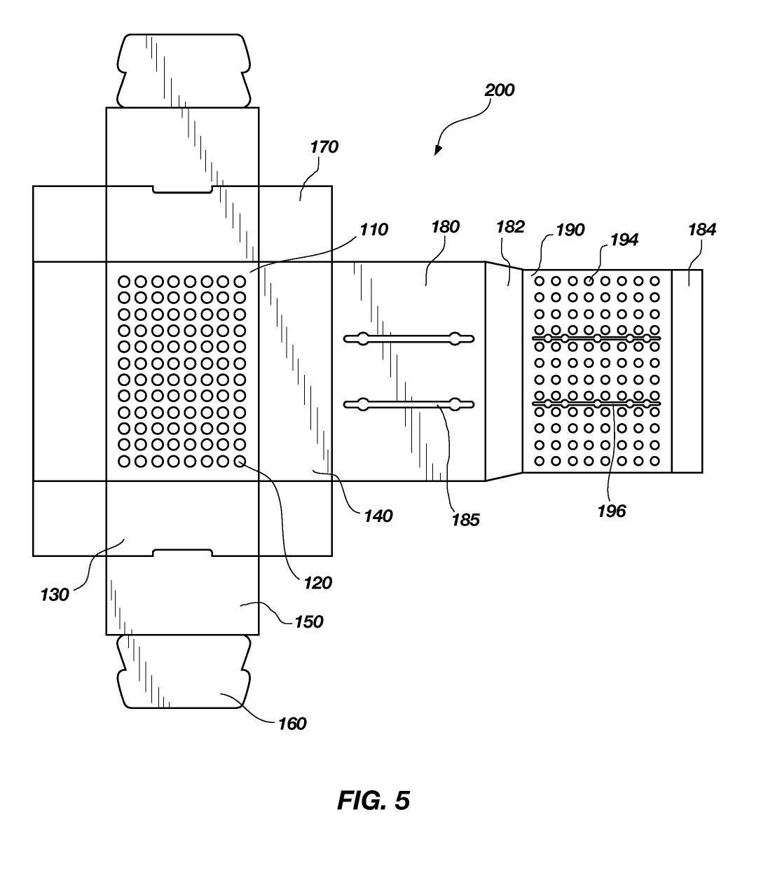

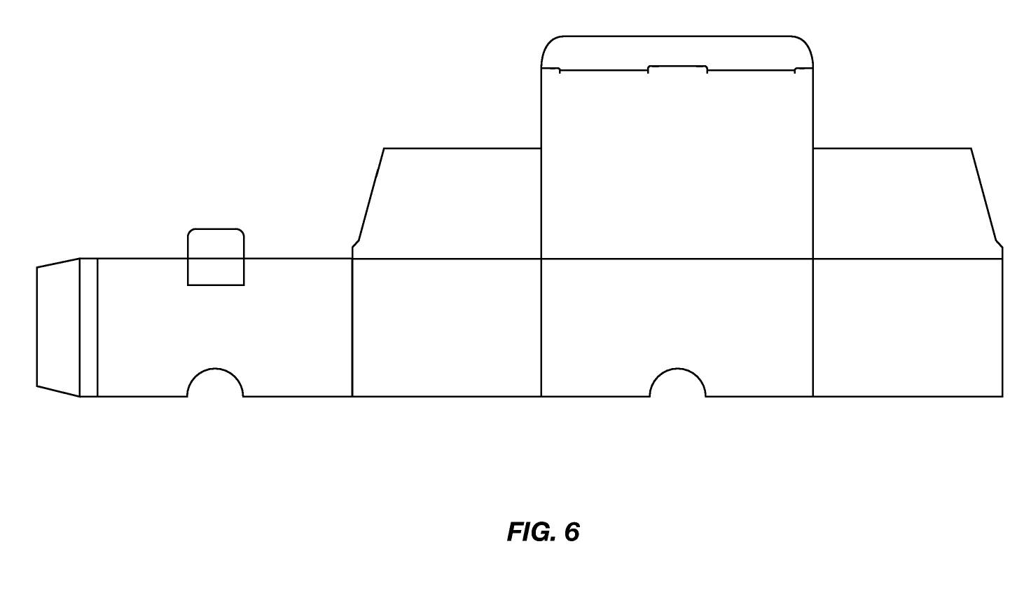

The lower panel 190 may be retained in position by side support walls 182, 184, which may be affixed to an inside surface of the side walls 140 of the container 100. The side support walls 182, 184 may be fixed to the inside surface of the sidewalls 140, for example, using an adhesive. An inner support wall 160 may extend from the floor 180 of the container 100 to the top wall 110 and may be configured to support the top wall 110. The floor 180 may include slits 185 (FIG. 5) therethrough for the inner support wall 160. When the end 135 is folded to a closed position, the inner support wall 160 may be inserted through the slit 185 as shown in FIG. 4. The lower panel 190 may include slits 196 (FIG. 5), and the inner support walls 160 may each extend through a slit 185 of the floor 180 and through a slit 185 of the lower panel 190 and contact an inside surface of the top wall 110. Thus, the inner support walls 160 may provide structural support for the top wall 110.

FIG. 5 depicts a blank 200 for forming the first embodiment of the container 100 of the invention. The blank 200 may be die cut from cardboard or paperboard. Examples of suitable materials include medical grade chipboard, CIS SBS or coded one side sodium bleach sulfate. The paperboard may be, for example, between about 15 point and about 36-point paperboard. This paperboard may have a thickness between about 0.15 millimeters and about 0.36 millimeters. One embodiment of a container 200 of the invention may comprise 24-point paperboard.

The container 100 may be used for storing, transporting, or dispensing pipette tips 300. The container 100 may provide support for the pipette tips 300 to be mounted on a manual or automatic pipettor. The pipette tips 300 may have sufficient support in the container to be mounted with a fluid-tight seal on the pipettor.

While this invention has been described in certain embodiments, the invention can be further modified within the spirit and scope of this disclosure. The formation of the pipette tip 300 of the invention may be described as using two shot molding, forming an inner component, and subsequently forming an outer component about the inner component. However, it will be understood by one skilled in the art that other methods of forming a multi-component pipette tip are within the scope of the invention. For example, the outer component may be formed prior to the inner component, or other molding methods may be used to form the multiple components. The term “pipette tip” as used herein, is intended to encompass all types of pipette tips, including pipette tips used for automated and manual pipetting, positive displacement pipettes, and all other pipette tips.

It is within the scope of the invention for the pipette tip 300 shown in FIG. 1 to comprise an O-ring or a sealing ring.

A rack described herein is advantageously used in combination with tips such as those described in US-2008-0078258 A1 to Price (Apr. 3, 2008). This publication describes multi-component tips that provide an improved seal with a pipette probe. These tips characteristically require less axial force to be applied by a probe to affect a suitable seal. By contrast, the biodegradable rack of this invention may be constructed to withstand relatively large probe forces, but may alternatively be constructed to withstand lower magnitude forces than are conventionally encountered in connection with pipetting procedures. These less robust racks require less material of construction, thereby reducing manufacturing cost, while being even more susceptible to biodegradation. Because the multi-component tips of the patent publication require less mounting force, they are ideally suited for use with the less robust versions of the racks of this invention. In a test procedure, mounting forces ranging from about 0.4 to about 20 lbs (0.2 to 10 kg) were applied by a probe to such tips held by a tip rack constructed of chip-board. A force of 0.4 lb (0.2 kg) was tolerated by the rack, and effected a good seal. The tip held the sample for well over a minute.

1. A container for a plurality of pipette tips, the container comprising:
a top panel including a plurality of apertures, each aperture configured for receiving a pipette tip of the plurality of pipette tips;
a floor panel; and
an intermediate panel between the top panel and the floor panel, the intermediate panel including a plurality of apertures, each aperture of the intermediate panel being aligned with an aperture of the top panel;
the top, floor, and intermediate panels being constructed of a biodegradable material, and wherein the top, floor, and intermediate panels are all formed from a single, unitary piece of the biodegradable material.

2. The container of claim 1, wherein the biodegradable material comprises cardboard.

3. In a pipette tip rack of the type constructed and arranged to hold a plurality of pipette tips in a specified arrangement for engagement by a probe, the improvement comprising:
constructing the pipette tip rack from a single unitary piece of biodegradable material selected and configured to resist forces applied by the probe during a tip-mounting operation.

4. The pipette tip rack of claim 3, wherein the biodegradable material comprises cardboard.

5. A container for receiving and holding a plurality of pipette tips, the container consisting of:
(a) a blank of cardboard or paperboard configured in a integral piece so as to comprise:
(i) a top panel including a plurality of apertures, each aperture thereof configured to receive a pipette tip of the plurality of pipette tips,
(ii) a floor panel, and
(iii) an intermediate panel positioned between the top and floor panels, the intermediate panel including a plurality of apertures therein, wherein each aperture of the intermediate panel aligns with an aperture of the top panel for receiving an associated pipette tip in an upright manner, and
(b) adhesive for associating said blank into said container,
wherein the container is biodegradable and constructed and arranged to hold a plurality of pipette tips in a specified arrangement for engagement by a probe during a tip-mounting operation and the top panel, intermediate panel and floor panel together form a pipette tip rack constructed and configured to resist forces applied by the probe during the tip-mounting operation.

6. The container of claim 5, wherein there are aligned apertures in the top and intermediate panels for receiving and holding ninety-six (96) pipette tips.
